(19) United States
(12) Patent Application Publication
(10) Pub. No.: US 2003/0055695 A1
(43) Pub. Date: Mar. 20, 2003

(54) Method and apparatus for managing project risk, and memory medium

(75) Inventors: Toshiki Mori, Kanagawa-ken (JP); Kosuke Ishii, Minato-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 09/953,128

(22) Filed: Sep. 17, 2001

(51) Int. Cl. G06F 17/60

(52) U.S. Cl. 705/7

(57) ABSTRACT

There is provided a project risk management method by using a Failure Modes and Effects Analysis (FMEA), comprising the steps of: inputting tasks (work items) of a project; generating a process model having information representing dependence relations among the tasks, information about an output of each task and information about a resource necessary for executing each task; and generating an applicant list of a failure mode by looking up the process model.

### BACKGROUND OF THE INVENTION

1. Field of the Invention This invention relates to a technology for assisting task/risk management such as a product development project.

2. Description of the Related Art

In a conventional projection management system, a manager first inputs processes necessary for executing a project, sets the expected starting date/expected completion date to plan a schedule of the project, and inputs the practical starting date/practical completion date to manage the progress condition. A chart that represents each process from the starting point to the ending point by a bar chart is generally referred to as a “Gantt chart”. This chart is a basic tool for the schedule planning of the project and the progress management. However, it is difficult according to the project management by means of the Gantt chart to clearly express a mutual dependence relation and a mutual retrogressive relation among tasks. Therefore, a DSM (Design Structure Matrix) has been proposed as a novel project management method. This DSM is a project management method that expresses the tasks involved in one project in a matrix form by arranging them into both rows and columns. The tasks arranged in the row or column direction are used as senders and the tasks arranged in the column or row direction, as receivers, and mutual dependence relations among the tasks are put into the corresponding positions of the matrix so that the input/output relations among the tasks can be clearly expressed. DSM expresses concisely the mutual dependence relations among the tasks of a complicated process and is suitable for analyzing association of the tasks. For further detail of this DSM, reference is to be had to MIT DSM home page (http://web.mit.edu/dsm/).

In the conventional project risk management method by Failure Modes and Effects Analysis (hereinafter called FMEA), the manager executes the risk management by analyzing and arranging the risks involved in the product and the process, and describing the result in the form including the items such as a failure mode, causes of a failure, effects of the failure (local effects and end effects), a detection method of the failure, RPN (Risk Priority Number) representing greatness of the risk, counter-measures against the risk, and so forth, into an FMEA table. The risk management generally comprises four steps, that is, “risk specification”, “risk determination”, “generation of counter-measures” and “control of counter-measures”. FMEA assists these basic steps of the risk management, and an FMEA table as the result of analysis by FMEA offers a standard document for the risk management.

The most difficult work in the conventional project risk management method using FMEA is “risk specification”, that is, the work for listing up all the failure modes that are involved in the project and can be thought of. Generally, a manager and staffs conduct brainstorming and specify the failure modes. However, the number of failure modes is generally very great in a complicated project, and important failure modes are likely to leak by ad-lib means such as brain storming. If any important failure mode leaks at the first stage, the result of subsequent works such as risk determination and generation of counter-measures become meaningless. Therefore, it is necessary to specify the failure mode as systematically as possible at the first stage in order to prevent the leak of important failure modes.

In a complicated project, chains of dependence of causes and effects of the failures are likely to interact with one another in complicated ways, and when the failure mode is specified, the failure mode and the causes and effects of the failures are mixed in many cases. To avoid such a problem, a clear standard must be established to distinguish the failure mode from the causes and effects.

To accomplish the object described above, the present invention provides means for generating a process model having information extracting tasks (work items) of a project and representing a mutual dependence relation among the tasks, information about an outputs of the tasks and information about resources necessary for executing each tasks, means for generating an applicant list of failure modes by looking up the process model, means for directly inserting the applicant list of the failure modes into an FMEA table and assisting the generation of the FMEA table, and means for asking a manager to input a concrete failure mode corresponding to the applicant of the failure modes by looking up the applicant list of the failure modes, and assisting interactively the generation of the FMEA table by inserting the inputted failure modes into the FMEA table.

Before executing the risk analysis by FMEA, the present invention generates a process model having information expressing a mutual dependence relation among tasks, information about an output of each task and information about a resource necessary for executing each task. The present invention allocates a “failure mode” in the process model to the task, “local effects” to the task output and “causes” to the resource, and generates the applicant list of the failure modes. In consequence, the present invention can specify comprehensively and systematically the failure modes, and can prevent the leak of important failure modes. Furthermore, the present invention can reduce the possibility that the failure modes are mixed with the causes and effects of the failures during the risk analysis process.

### BRIEF SUMMARY OF THE INVENTION

According to embodiments of the present invention, a project risk management method by using a Failure Modes an Effects Analysis (FMEA), comprising the steps of: inputting tasks (work items) of a project; generating a process model having information representing dependence relations among the tasks, information about an output of each task and information about a resource necessary for executing each task; and generating an applicant list of a failure mode by looking up the process model.

According to another embodiments of the present invention, a project risk management apparatus for use in a project risk management method by using a Failure Modes and Effects Analysis (FMEA), comprising: inputting means for inputting tasks (work items) of a project; memory means for storing a dependence relation among tasks; memory means for storing information about an output of each task; memory means for storing information about a resource necessary for executing each task; process model generation means for generating a process model having the dependence information among the tasks and the information about the task output and the resource; and failure mode applicant list generation means for generation an applicant list of a failure mode by looking up the process model.

### BRIEF DESCRIPTION OF THE DRAWINGS

FIG. 1 is a schematic structural view showing a project risk management method and a display device according to one embodiment of the present invention;

FIG. 2 is a table showing an example of DSM data that express a mutual dependence relation among tanks in a matrix form;

FIG. 3 is a table showing DSM data obtained by re-arranging a task sequence by a function of “partitioning” provided to DSM;

FIG. 4 is a flowchart showing a preceding relation and a retrogressive relation of a task;

FIG. 5 is a table showing an example of attribute information of tasks;

FIG. 6 is a flowchart showing an algorithm for generating an applicant list of a failure mode from information of mutual dependence relation among tasks and attribute information of tasks;

FIG. 7 is a flowchart showing an algorithm of an allocating processing of “failure end effect” and “detection”;

FIG. 8 is a table showing an applicant list of a failure mode generated for task “vehicle basic dimension decision”’

FIG. 9 is a table showing an example where an applicant list of a failure mode is directly inserted into an FMEA table;

FIG. 10 shows an example of a generation wizard of an FMEA failure mode; and

FIG. 11 shows an example where a scenario of the failure mode generated is inserted into the FMEA table.

### DESCRIPTION OF THE PREFERRED EMBODIMENT

Hereinafter, a preferred embodiment of the present invention will be explained in detail with reference to the accompanying drawings.

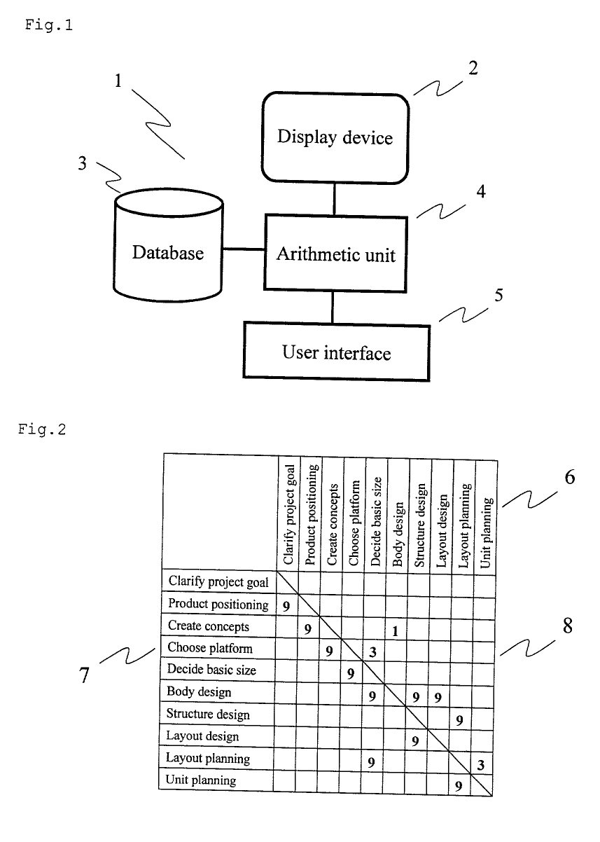

FIG. 1 is a schematic structural view showing a project risk management method and a display apparatus according to one embodiment of the present invention. The project risk management method and the display apparatus system 1 according to this embodiment include a display device 2, a data base 3, an arithmetic unit 4 and an interface 5. The data base 3 stores a list of tasks contained in a project, a DSM data representing a mutual dependence relation among the tasks, attribute information of each task, that is, information about a task output and resources, and FMEA data. The arithmetic unit 4 looks up the DSM data and the task attribute information and generates an applicant list of a failure mode. The applicant list of the failure mode so generated is displayed on the display device 2. When the DSM data, the task attribute information and the FMEA data are added/deleted/corrected, the DSM data, the task attribute information and the FMEA data stored in the database 3 are corrected via the interface 5.

FIG. 2 shows an example of the DSM data representing the mutual dependence relation among the tasks in a matrix form. The explanation will be given hereby on a task associated with “development of car” by way of example.

The first row of DSM represents an input task part 6. The first column of DSM represents an output task part 7. The second and subsequent rows and columns of DSM represent a dependence relation expression part 8. The same task name is arranged in the input task part 6 and in the output task part 7 in the same order. A numeral in the dependence relation expression part 8 represents that a dependence relation exists between the input task and the output task, and greatness of the numeral represents the degree of the dependence relation. It will be assumed hereby that the greater the numeral, the greater the dependence relation between the tasks. Numeral 9 in the 5^{th} row and 4^{th} column, for example, represents that the dependence relation from the input task “merchandise concept generation” to the output task “car construction decision” and the degree of greatness of the relation is 9. The DSM data can concisely express in this way the complicated mutual dependence relation among the tasks in the matrix form.

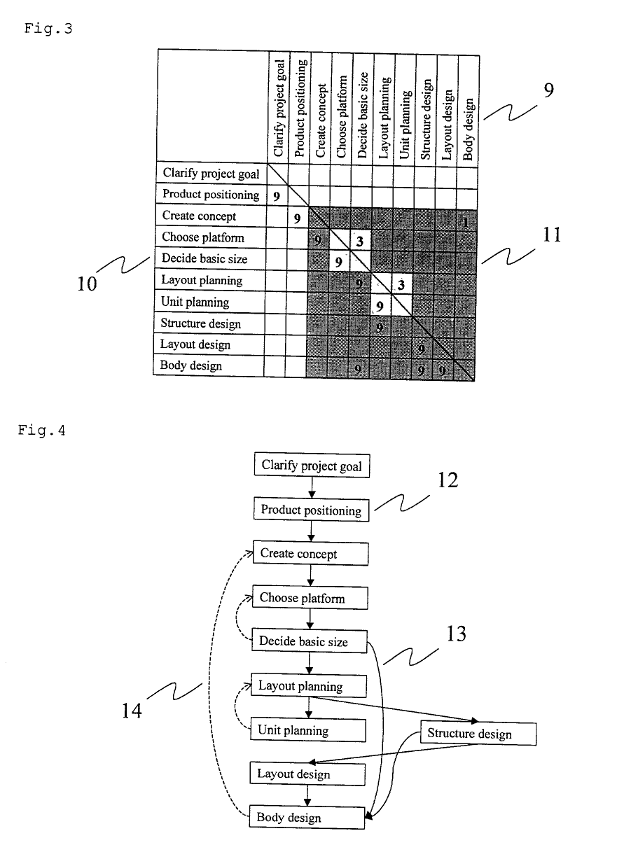

FIG. 3 shows DSM data obtained by re-arranging the task sequence by a function “partitioning” provided to DSM. This “partitioning” function re-arranges the task sequence in such a fashion that the numeral elements of the upper triangular matrix portion (the portion above the diagonal) becomes as small as possible. As a result, the task sequence of the input task portion 9 or the output task portion 10 is replaced. For instance, whereas “design” is positioned at the 5^{th} position of the input task portion 6 or the output task portion 7, it is positioned at the last position of the input task portion 9 or the output task portion 10. With the replacement of the task sequence, the positions of the numerals contained in the dependence relation expression part 11 change, too. Since the function “partitioning” re-arranges the task sequence in such a fashion as to minimize the numeral elements of the upper triangular matrix portion of the dependence relation expression part 11, the upper triangular matrix portion of the dependence relation expression part 8 in FIG. 2 contains three “9”, two “3” and one “1” or six numerical elements, in total, but the upper triangular matrix portion of the dependence relation expression part 11 in FIG. 3 contains two “3” and one “1”, that is, three numerical elements, in total.

It will be assumed that the DSM data shown in FIG. 3 is interpreted by executing the tasks in the sequence of from the left of the input task part 9 to the right or from above to down of the output task part 10. Then, the lower triangular matrix portion of the dependence relation expression part 11 (the portion below the diagonal) can be interpreted as representing the precedent relation of the task whereas the upper triangular matrix portion, as representing the retrogressive relation. The block of the dependence relation expression part 11 represents the influence range of the retrogressive relation. The tasks that can be executed are arranged in sequence on the basis of the assumption described above. When arrows are used to connect the mutual dependence relation among the tasks, the flowchart is obtained as shown in FIG. 4. Boxes 12 represent the tasks, and the tasks are serially executed from above to below. Arrows 13 of solid line represent the preceding relation among the tasks and arrows 14 of dotted line represent the retrogressive relation. The arrow from “basic construction decision” to “layout decision”, for example, is the preceding relation of the tasks and the arrow from “design” to “merchandise concept generation” is the retrogressive relation of the tasks. The arrow representing the preceding or retrogressive relation of the tasks corresponds to each numerical element of the dependence relation expression part 11 shown in FIG. 3.

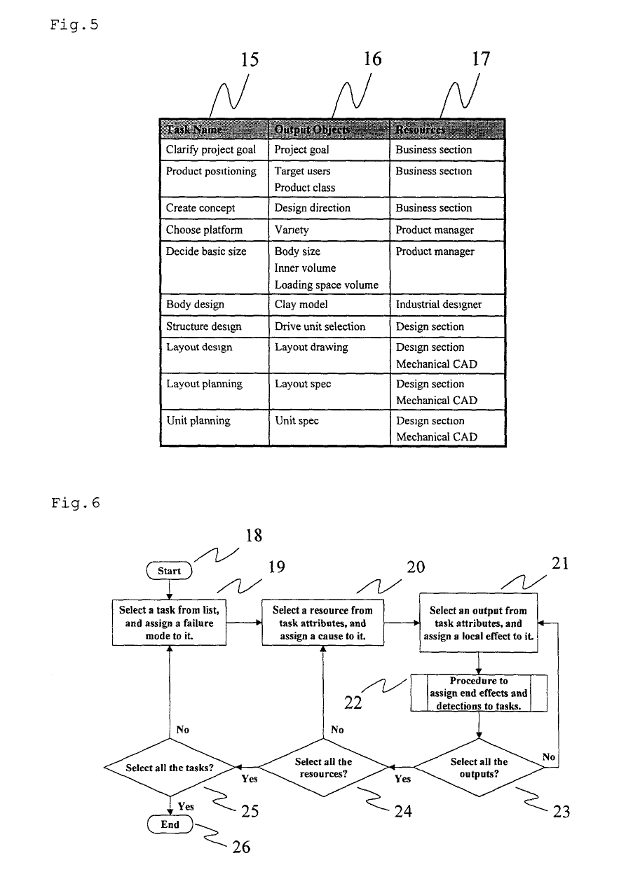

FIG. 5 shows the attribute information of the task. Each row of the table represents a task output 16 and a resource 17 corresponding to the task 15. The output task “car basic dimension decision”, for example, includes “car outer dimension”, “car inner space dimension” and “load space dimension”, and the resource is “product planning.

FIG. 6 shows an algorithm for generating an applicant list of a failure mode from the information of the dependence relation among the tasks and the task attribute information. A processing 19 starts from a starting point 18, selects one task from the list of all tasks, and allocates “failure mode” to the failure of the task. In the next processing 20, the attribute information of the selected task is looked up, one resource is selected from the list of all resources, and “cause of failure” is allocated. In the subsequent processing 21, the attribute information of the selected task is looked up, one task output is selected from the list of all task outputs, and “local influence of failure” is allocated. After the allocation processing of “end influence of failure” and “detection” are executed in the processing 22, the processing 23 judges whether or not all the task outputs are selected in the list of all task outputs for the selected task. When all the task outputs are not selected, the flow returns to the processing 21. Otherwise, the flow shifts to a condition branch 24, and whether or not all the resources are selected in the list of all the resources for the selected task is judged. When all the resources are not selected, the flow returns to the processing 20. Otherwise, the flow shifts to a condition branch 25, and whether or not all the tasks are selected in the list of all the tasks is judged. When all the tasks are not selected, the flow returns to the processing 19. Otherwise, the flow shifts to the end 26, and the processing for generating the applicant list of the failure mode is completed.

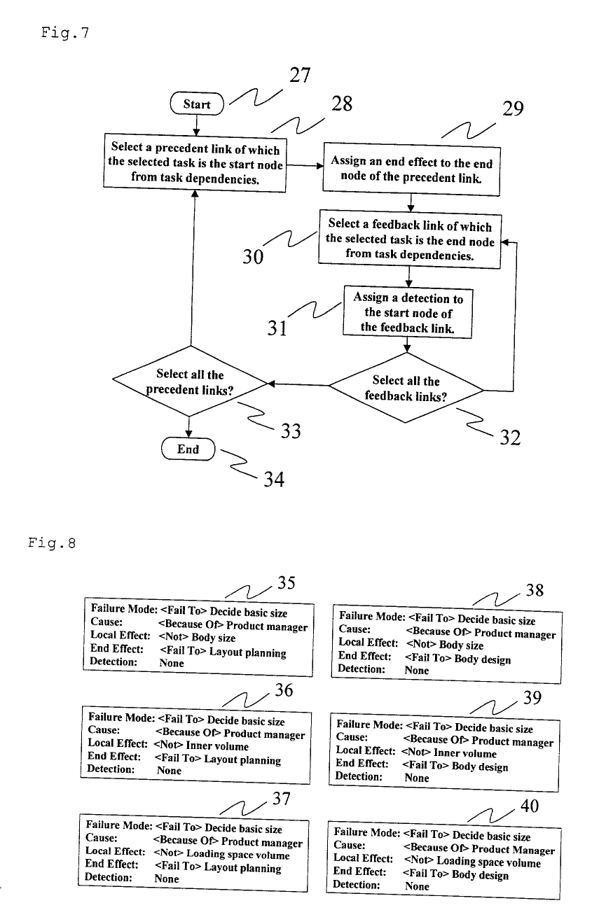

FIG. 7 is a flowchart showing in detail the algorithm for allocation processing of “end influence of failure” and “detection”, corresponding to the processing 22 in FIG. 6. From the start 27, the information of the mutual dependence relation among the tasks is first looked up in the processing 28, and one precedent relation is selected from the list of all the precedent relations starting from the selected task. In the next processing 29, the failure of the task is assumed for the task at the end of the selected precedent relation, and “end effects of failure” is allocated. In the subsequent processing 30, the information of the mutual dependence relation among the tasks is looked up and one retrogressive relation is selected from the list of all the retrogressive relations having the selected task as the end point. In the processing 31, when the task at the start of the selected retrogressive relation can be reached from the task at the end of the selected precedent relation, “detection” is allocated to the task at the starting point. A processing of a branch condition 32 judges whether or not all the retrogressive relations are selected in the list of all the retrogressive relations having the selected task as the end point. When all the retrogressive relations are not selected, the flow returns to the processing 30. Otherwise, the flow shifts to the branch condition 33, and whether or not all the precedent relations are selected in the list of all the precedent relations having the selected task as the starting point is judged. When all the precedent relations are not selected, the flow returns to the processing 28. Otherwise, the flow shifts the endpoint 34, and the allocation processing of “end influence of failure” and “detection” is completed.

FIG. 8 shows the applicant list of the failure mode generated by the application of the algorithms shown in FIGS. 6 and 7 to the task “car basic dimension decision”. Reference numerals 35 to 40 denote the applicants of the failure mode associated with the failure of “car basic dimension decision”. When similar operations are executed for all the tasks contained in the project, the applicant list of the failure mode in the project can be generated on the basis of the information of the mutual dependence relation among the tasks and the task attribute information.

FIG. 9 shows an example where the applicant list of the failure mode is directly inserted into the FMEA table by looking up the applicant list of the failure mode. In the example of the “car development” project, 28 applicants of the failure mode are generated and put into the FMEA table. A manager of the project looks up the template of this FMEA table and sorts out the practical failure mode by conducting brain storming, or the like.

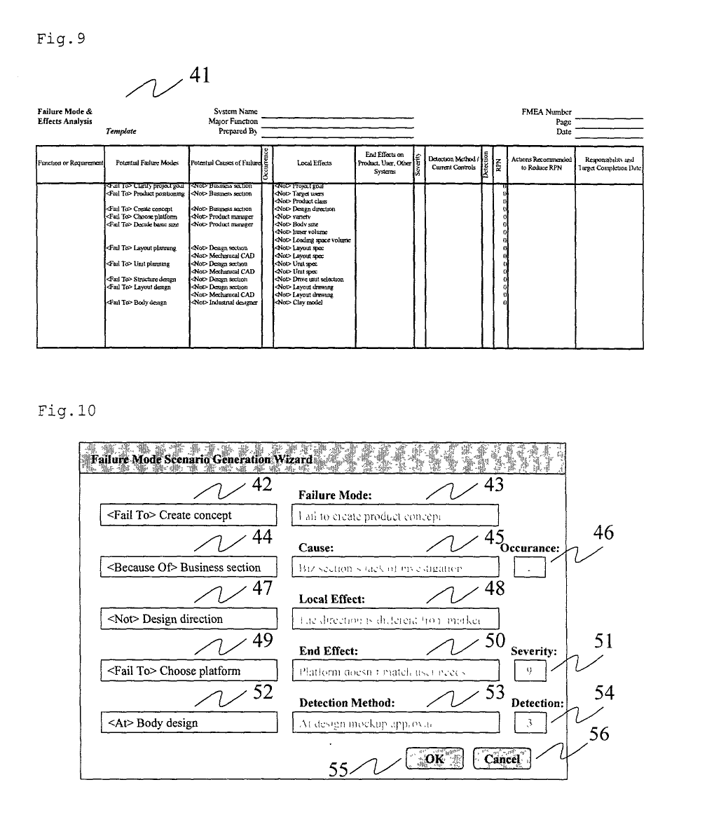

FIG. 10 shows a concrete example of means for asking the manager to input the concrete failure mode corresponding to the applicant of the failure mode by looking up the applicant list of the failure mode, and for interactively assisting the generation of the FMEA table. FIG. 10 shows a generation wizard of the FMEA failure mode. Reference numerals 42, 44, 47, 49 and 52 are the expression of the applicant list of the generated failure mode inside the computer. By looking up this wizard, the manager or operator describes the scenario of the concrete failure mode into the columns 43, 45, 46, 48, 50, 51, 53 and 54. In other words, the concrete expression of the failure mode corresponding to “failure mode” 42 is described. The concrete expression of the cause corresponding to “cause of failure” 44 is described into 45, and its occurrence frequency is described into 46. The concrete expression of the local effects corresponding to “local effects of failure” 47 is described into 48. The concrete expression of the end effects corresponding to “local effects of failure” 49 is described into 50 and greatness of its effects, into 51. The concrete expression of the detection means corresponding to “detection of failure” 52 is described into 53 and the level of its detection, into 54. The scenario of the failure mode generated interactively in this way is inserted into the FMEA table when an OK button 55 is pushed.

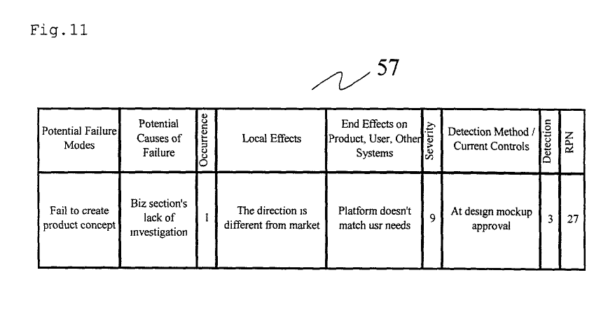

FIG. 11 shows an example where the scenario of the failure mode generated as described above is inserted into the FMEA table. When repeating such an operation for the applicant list of the failure mode, the manager or the operator can interactively complete FMEA.

The embodiment given above does not limit the scope of the present invention, and the present invention includes various embodiments other the one described above.

The present invention can stipulate comprehensively and systematically the failure mode and can prevent leak of an important failure mode. Furthermore, the present invention can reduce the possibility of mixing the failure mode, the cause of the failure and the effects of the failure during the process for analyzing the risk. Accordingly, the present invention can generate more easily the FMEA table for large-scale projects the generation of which has been extremely complicated and troublesome in the past.

What is claimed is:

1. A project risk management method by using a Failure Modes and Effects Analysis(FMEA), comprising the steps of:
inputting tasks of a project;
generating a process model having information representing dependence relations among the tasks, information about an output of each task, and information about a resource necessary for executing each task; and
generating an applicant list of a failure mode by looking up the process model.

2. The project risk management method according to claim 1, which further comprises the steps of:
looking up the applicant list of the failure mode; and
inserting the applicant list of the failure mode into an FMEA table.

3. The project risk management method according to claim 1, which further comprises the steps of:
looking up the applicant list of the failure mode;
inputting a concrete failure mode corresponding to the applicant of the failure mode; and
inserting the failure mode so inputted into an FMEA table.

4. A project risk management apparatus for use in a project risk management method by using a Failure Modes and Effects Analysis(FMEA), comprising:
inputting apparatus configured to input tasks of a project;
memory configured to store a dependence relation among tasks;
memory configured to store information about an output of each task;
memory configured to store information about a resource necessary for executing each task;
process model generator configured to generate a process model having the dependence information among the tasks and the information about the task output and the resource; and
failure mode applicant list generator to generate an applicant list of a failure mode by looking up the process model.

5. The project risk management apparatus according to claim 4, which further comprises:
FMEA generator configured to insert the applicant list of the failure mode into an FMEA table by looking up the applicant list of the failure mode.

6. The project risk management apparatus according to claim 4, which further comprises:
failure mode inputting apparatus configured to input a concrete failure mode corresponding to the applicant of the failure mode by looking up the applicant list of the failure mode; and
FMEA generator configured to insert the failure mode so inputted into an FMEA table.

7. A recording medium recording thereon a software for executing the method by using a Failure Modes and Effects Analysis(FMEA), comprising the steps of:
inputting tasks of a project;
generating a process model having information representing dependence relations among the tasks, information about an output of each task, and information about a resource necessary for executing each task; and
generating an applicant list of a failure mode by looking up the process model.

8. The recording medium according to claim 7, which further comprises the steps of:
looking up the applicant list of the failure mode; and
inserting the applicant list of the failure mode into an FMEA table.

9. The recording medium according to claim 7, which further comprises the steps of:
looking up the applicant list of the failure mode;
inputting a concrete failure mode corresponding to the applicant of the failure mode; and
inserting the failure mode so inputted into an FMEA table.
